(19) United States
(12) Patent Application Publication
(10) Pub. No.: US 2010/0001575 A1
(43) Pub. Date: Jan. 7, 2010

(54) UNIFIED RIM HORN

(75) Inventors: Matthew Brest, Hudson, OH (US); Endre Lovasi, Szekesfehervar (HU); Csaba Toth, Szekesfehervar (HU)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: ALCOA WHEEL PRODUCTS EUROPE SERVICES AND TRADING LIMITED LIABILITY COMPANY, Szekesfehervar (HU)

(21) Appl. No.: 12/167,709

(22) Filed: Jul. 3, 2008

(51) Int. Cl. B60B 1/00; B60B 21/00

(52) U.S. Cl. 301/95.101; 301/5.21

(57) ABSTRACT

An apparatus and method for a wheel rim that is able to accommodate both clip-on balancing weights and stick-on balancing weights are disclosed involving a wheel rim having a wheel rim area comprising an outboard tire bead retaining flange, an outboard bead seat, a rounded axial protuberance, an outboard deep well side wall, a deep well, an inboard deep well side wall, an inboard bead seat, and an inboard tire bead retaining flange. The length of the outboard bead seat is equal to twice the length of the outboard bead-retaining flange. In addition, the length of the inboard bead seat is equal to twice the length of the inboard bead-retaining flange. Clip-on balancing weights are affixed to outboard tire bead retaining flange and/or the inboard tire bead-retaining flange. In addition, stick-on balancing weights are affixed to the outboard bead seat and/or the inboard bead seat.

### BACKGROUND OF THE DISCLOSURE

The present disclosure relates to wheel rims. In particular, it relates to wheel rims that are able to accommodate both clip-on balancing weights and stick-on balancing weights.

### SUMMARY OF THE DISCLOSURE

The present disclosure relates to an apparatus and method for a wheel rim that is able to accommodate clip-on balancing weights as well as stick-on balancing weights. In one or more embodiments, the apparatus and method involves a wheel rim having a rim area comprising an outboard tire bead retaining flange, an outboard bead seat, a rounded axial protuberance, an outboard deep well side wall, a deep well, an inboard deep well side wall, an inboard bead seat, and an inboard tire bead retaining flange.

In one or more embodiments, the outboard tire bead retaining flange transitions to the outboard bead seat, the outboard bead seat transitions to the rounded axial protuberance, the rounded axial protuberance transitions to an outboard deep well side wall, the outboard deep well side wall transitions to a deep well, the deep well transitions to an inboard deep well side wall, the inboard deep well side wall transitions to an inboard bead seat, and the inboard bead seat transitions to an inboard tire bead retaining flange.

In one or more embodiments, the length of the outboard bead seat is equal to twice the length of the outboard bead-retaining flange. In addition, the length of the inboard bead seat is equal to twice the length of the inboard bead-retaining flange. In addition, at least one clip-on balancing weight may be affixed to the outboard tire bead-retaining flange, and at least one clip-on balancing weight may be affixed to the inboard tire bead-retaining flange. Additionally, at least one stick-on balancing weight may be affixed to the outboard bead seat, and at least one stick-on balancing weight may be affixed to the inboard bead seat.

In one or more embodiments, the wheel rim further comprises a wheel disk area. The wheel disk area includes a centrally disposed pilot opening. In addition, the wheel disk area includes a plurality of apertures, where the plurality of apertures are to receive mounting studs. In addition, the wheel disk area includes a plurality of through openings. The plurality of through openings are circular shape. Additionally, the at least one clip-on balancing weight comprises a balancing weight body and a clip. The balancing weight body of the at least one clip-on balancing weight is manufactured from lead. In addition, the outboard tire bead-retaining flange is formed to have a rounded, bulbous lip. Similarly, the inboard tire bead-retaining flange is also formed to have a rounded, bulbous lip.

### BRIEF DESCRIPTION OF THE DRAWINGS

These and other features, aspects, and advantages of the present disclosure will become better understood with regard to the following description, appended claims, and accompanying drawings where:

FIG. 1 is a side view of the environment and the disclosed wheel rim as used in accordance with one or more embodiments of the present disclosure.

FIG. 2 is a cross-sectional perspective view of the disclosed wheel rim employing both clip-on balancing weights and stick-on balancing weights in accordance with one or more embodiments of the present disclosure.

FIG. 3 is a cross-sectional view of the disclosed wheel rim employing clip-on balancing weights in accordance with one or more embodiments of the present disclosure.

FIG. 4 is a cross-sectional view of the disclosed wheel rim employing stick-on balancing weights in accordance with one or more embodiments of the present disclosure.

FIG. 5 is a cross-sectional view of the disclosed wheel rim employing both clip-on balancing weights and stick-on balancing weights in accordance with one or more embodiments of the present disclosure.

FIG. 6 is a cross-sectional view of the disclosed wheel rim employing both stick-on balancing weights and clip-on balancing weights in accordance with one or more embodiments of the present disclosure.

### DETAILED DESCRIPTION

The apparatus and methods disclosed herein provide an operative system for a wheel rim that is able to accommodate both clip-on balancing weights and stick-on balancing weights. There are two main types of balancing weights that are utilized to balance wheels. These two types are clip-on balancing weights and stick-on balancing weights. Currently, wheel rims are designed and manufactured such that they are only able to accommodate one type of balancing weight, either a clip-on type of balancing weight or a stick-on type of balancing weight. Thus, these two main types of balancing weights are not interchangeable for the same wheel rim. The present disclosure sets forth a wheel rim that employs a unified rim horn flange, which enables the wheel rim to accommodate either clip-on type balancing weights and/or stick-on type balancing weights.

In the following description, numerous details are set forth in order to provide a more thorough description of the system. It will be apparent, however, to one skilled in the art, that the disclosed system may be practiced without these specific details. In the other instances, well known features have not been described in detail so as to not unnecessarily obscure the system.

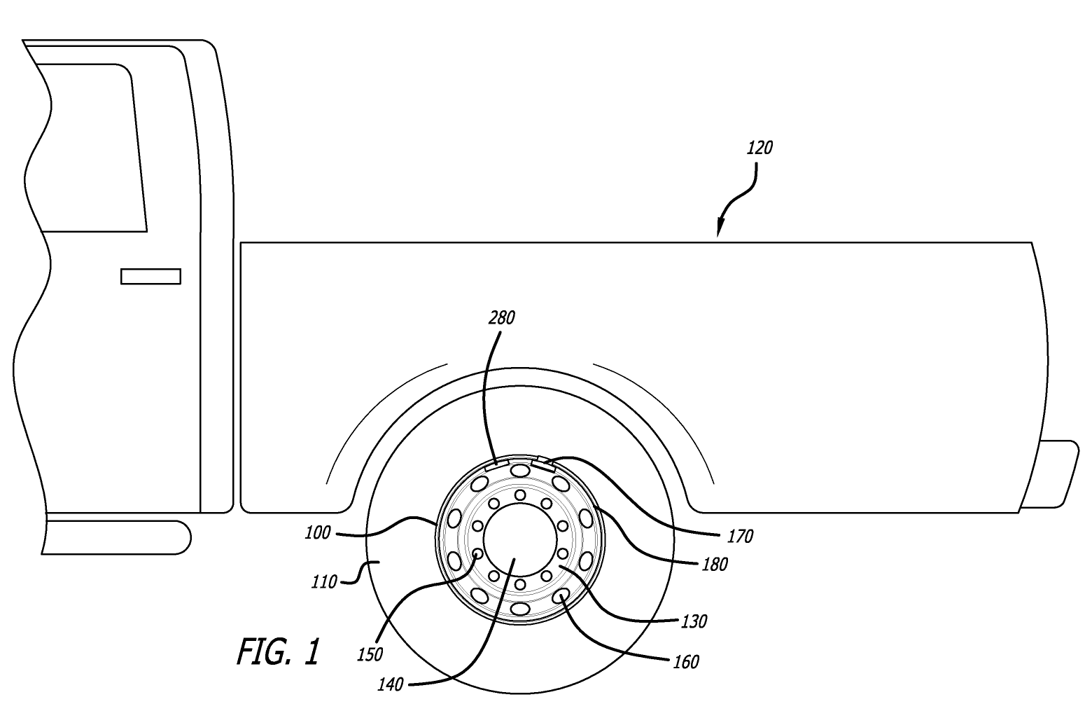

FIG. 1 contains a side view of the environment and the disclosed wheel rim as used in accordance with one or more embodiments of the present disclosure. In this figure, the wheel rim 100 is installed onto a tire 110 of any of the axles of a vehicle 120. Various types of vehicles 120 may employ the wheel rim 100 of the present disclosure including, but not limited to, passenger vehicles, commercial vehicles, as well as recreational vehicles. In addition, in one or more embodiments, the wheel rim 100 of the present invention may be manufactured from various metals and/or metal alloys including, but not limited to, aluminum and steel.

The wheel rim 100 includes a wheel disk area 130. The wheel disk area 130 includes a centrally disposed pilot opening 140 and a plurality of apertures 150. The plurality of apertures 150 are to receive mounting studs (not shown) that are used to mount the wheel rim 100 and tire 110 to the vehicle 120. The mounting studs (not shown), when placed within the apertures 150, will extend from the wheel hub (not shown) on the vehicle 120.

In one or more embodiments, the wheel disk area 130 includes a plurality of spokes and/or other structures, which are used to define a plurality of through openings 160. The through openings 160 assist in ventilation of the brake assembly (not shown) of the vehicle 120. The through openings 160 may be of various sizes and shapes including, but not limited to, circular shapes and triangular shapes. In addition, the visible outboard side of the wheel disk area 130 may be manufactured according to various designs including, but not be limited to, spoke designs, basket weave designs, and solid disk designs.

In one or more embodiments, a clip-on balancing weight 170 is attached to the outboard tire bead-retaining flange 180 of the wheel rim 100. The body of the clip-on balancing weight 170 is fixed to the outboard face of the outboard tire bead-retaining flange 180, and the clip of the clip-on balancing weight 170 extends radially about the outer edge of the inboard face of the outboard tire bead-retaining flange 180 to grip the outboard tire bead-retaining flange 180. In one or more embodiments, a stick-on balancing weight 190 is attached to the radial inner surface of the outboard face of the wheel rim 100.

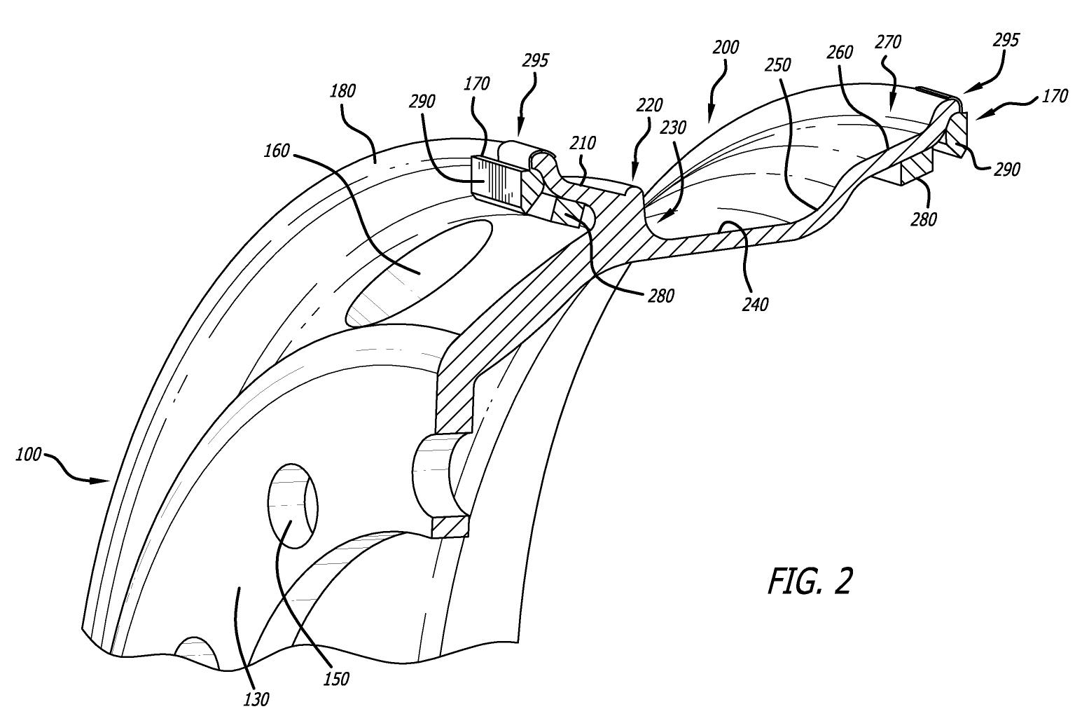

FIG. 2 illustrates a cross-sectional perspective view of the disclosed wheel rim employing both clip-on and stick-on balancing weights in accordance with one or more embodiments of the present disclosure. This cross-sectional view shows the rim area 200 of the wheel rim 100. The rim area 200 includes an outboard tire bead-retaining flange 180, an outboard bead seat 210, a rounded axial protuberance 220, an outboard deep well sidewall 230, a deep well 240, an inboard deep well sidewall 250, an inboard bead seat 260, and an inboard tire bead-retaining flange 270.

The outboard tire bead-retaining flange 180 is formed to have a rounded, bulbous lip. The outboard tire bead retaining flange 180 transitions to one end of an outboard bead seat 210. The combination of the outboard tire bead-retaining flange 180 and the outboard bead seat 210 form a unified rim horn structure. The opposite end of the outboard bead seat 210 transitions to a rounded axial protuberance 220. The rounded axial protuberance 220 transitions at a downward angle to one end of an outboard deep well side wall 230. The opposite end of the outboard deep well sidewall 230 transitions to one end of a relatively flat deep well 240.

The opposite end of the deep well 240 transitions at an upward angle to one end of an inboard deep well sidewall 250. The opposite end of the inboard deep well sidewall 250 transitions to one end of an inboard bead seat 260. The opposite end of the inboard bead seat 260 transitions to an inboard tire bead-retaining flange 270. The inboard tire bead-retaining flange 270 is formed to have a rounded, bulbous lip. The combination of the inboard bead seat 260 and the inboard tire bead retaining flange 270 form a unified rim horn structure.

In one or more embodiments, after a tire 110 is mounted on a wheel rim 100, an evaluation of the balance of the combined tire 110 and wheel rim 100 assembly is performed. If the combined tire 110 and wheel rim 100 assembly is not balanced, premature and abnormal wear of the tire 110 may result. There are two main methods utilized for balancing the combined tire 110 and wheel rim 100 assembly. These two methods are static balancing and dynamic balancing.

When the method of static balancing is employed, the combined tire 110 and wheel rim 100 assembly is placed onto a balance (not shown). While the combined tire 110 and wheel rim 100 assembly is on the balance, the direction of the tilting of the wheel assembly is noted. Then, a balancing weight of a specific weight is affixed to wheel rim 100 to bring the wheel assembly back to a level, non-tilted, balanced condition. Many retail tire outlets use the method of static balancing to balance wheel assemblies.

Various types of balancing weights may be affixed to the wheel rim 110 to balance the combined tire 110 and wheel rim 100 assembly. The two main types of balancing weights that are used are clip-on balancing weights 170 and stick-on balancing weights 280. Clip-on balancing weights 170 comprise a balancing weight body 290 and a clip 295. The balancing weight body 290 of the clip-on balancing weight 170 may be manufactured from lead or zinc. The balancing weight body 290 is typically cast onto a clip 295 made from steel. However, alternatively, in one or more embodiments, the balancing weight body 290 and/or the clip 295 of the clip-on balancing weight 170 may be manufactured from other various metals or metal alloys.

Stick-on balancing weights 190 comprise a balancing weight body. The balancing weight body of the stick-on weight 190 may be manufactured from lead or zinc. However, alternatively, in one or more embodiments, the balancing weight body of the stick-on balancing weight 190 may be manufactured from other various metals or metal alloys. Stick-on balancing weights are affixed to wheel rims by various means including, but not limited to, adhesion by the use of various glues or bonding agents.

In one or more embodiments of the disclosed wheel rim 100, clip-on balancing weights 170 may be affixed to the outboard tire bead-retaining flange 180 and/or the inboard tire bead-retaining flange 270. When a clip-on balancing weight 170 is affixed to the outboard tire bead retaining flange 180, the clip 295 of the clip-on balancing weight 170 extends radially about the outer edge of the inboard face of the outboard tire bead retaining flange 180, and the balancing weight body 290 of the clip-on balancing weight 170 is held against the outboard face of the outboard tire bead retaining flange 180. Similarly, when a clip-on balancing weight 170 is affixed to the inboard tire bead retaining flange 270, the clip 295 of the clip-on balancing weight 170 extends radially about the outer edge of the outboard face of the inboard tire bead retaining flange 270, and the balancing weight body 290 of the clip-on balancing weight 170 is held against the inboard face of the inboard tire bead retaining flange 180.

When a clip-on balancing weight 170 is affixed to the outboard tire bead retaining flange 180, the combined tire 110 and wheel rim 100 assembly is brought to static balance. However, the axial offset from the clip-on balancing weight 170 to the center of gravity of the combined tire 110 and wheel rim 100 assembly can create a force, which causes the wheel assembly to shake and wobble while the wheel assembly is rotating during operation of the vehicle 120. This shaking and wobbling of the wheel assembly can cause the tire 110 to wear unevenly. In order to reduce the force that causes the shaking and wobbling of the wheel assembly, the total balancing weight required to balance the wheel assembly is typically divided in half. Half of the required balancing weight will be applied to the wheel assembly in the form of clip-on balancing weights 170 affixed to the outboard tire bead-retaining flange 180 and the remaining half of the required balancing weight will be applied in the form of clip-on balancing weights 170 affixed to the inboard tire bead-retaining flange 270.

The other main type of balancing weights that is used to assist in balancing combined tire 110 and wheel rim 100 assemblies is stick-on balancing weights 280. Stick-on balancing weights 280 typically have an adhesive backing for fastening the stick-on balancing weights 280 to the radial inner surface of the wheel rim area 200. Alternatively, in one or more embodiments, stick-on balancing weights may be affixed to the radial inner surface of the wheel rim area 200 by various means other than adhesion.

In one or more embodiments of the disclosed wheel rim 100, stick-on balancing weights 280 may be affixed to the outboard bead seat 210 and/or the inboard bead seat 260 of the wheel rim 100. When a stick-on balancing weight 280 is affixed to the outboard bead seat 210 of the wheel rim 100, the stick-on balancing weight 280 is fastened to radial inner surface of the outboard bead seat 210 of the wheel rim 100. And, similarly, when a stick-on balancing weight 280 is affixed to the inboard bead seat 260 of the wheel rim 100, the stick-on balancing weight 280 is fastened to radial inner surface of the inboard bead seat 260 of the wheel rim 100.

The other main method for balancing wheel assemblies is dynamic balancing. When the method of dynamic balancing is performed on the combined tire 110 and wheel rim 100 assembly, the combined tire 110 and wheel rim 100 assembly is rotated. During the rotation of the wheel assembly, the force and direction of the imbalance of the wheel is noted. Clip-on balancing weights 170 are affixed to the outboard bead-retaining flange 180 as well as the inboard bead-retaining flange 260 at specific locations of the wheel rim 100 that are calculated to bring the wheel assembly into dynamic balance. In addition, the clip-on balancing weights 170 to be used are chosen to be specific weights that are calculated to minimize the unbalancing force.

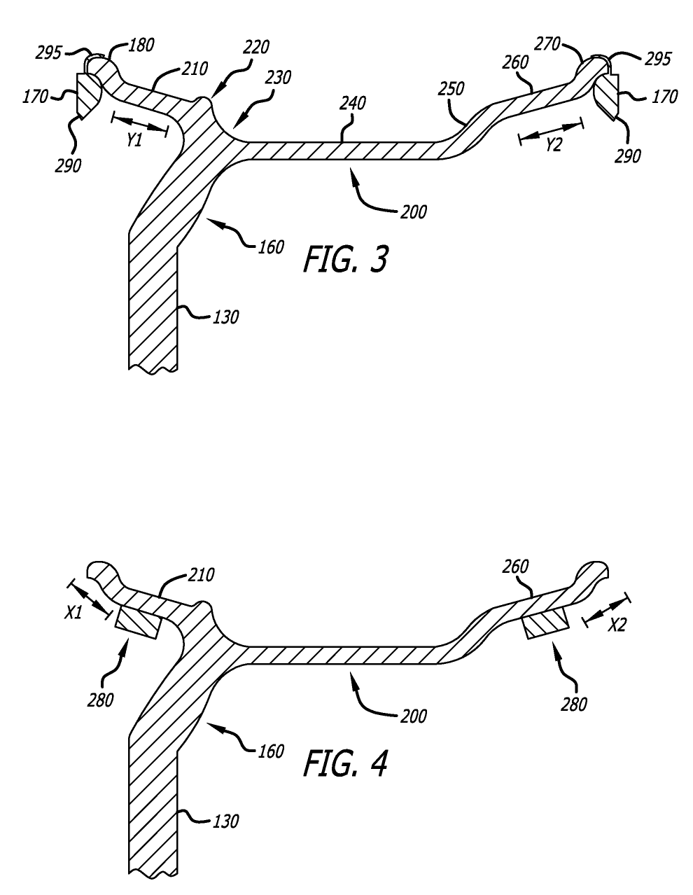

FIG. 3. contains a cross-sectional view of the disclosed wheel rim employing clip-on balancing weights in accordance with one or more embodiments of the present disclosure. In this figure, clip-on balancing weights 170 are affixed to both the outboard tire bead-retaining flange 180 as well as the inboard tire bead-retaining flange 270. The clip-on balancing weight 170 that is affixed to the outboard tire bead retaining flange 180 has its clip 295 extending radially about the outer edge of the inboard face of the outboard tire bead retaining flange 180 and its balancing weight body 290 held against the outboard face of the outboard tire bead retaining flange 180. Similarly, the clip-on balancing weight 170 that is affixed to the inboard tire bead retaining flange 270 has its clip 295 extending radially about the outer edge of the outboard face of the inboard tire bead retaining flange 270 and its balancing weight body 290 held against the inboard face of the inboard tire bead retaining flange 180.

The particular view shown in this figure clearly illustrates the unique structure of the disclosed wheel rim 100, which is able to accommodate both clip-on balancing weights 170 and stick-on balancing weights 280. The wheel rim area 200 of the wheel rim 100 comprises an outboard tire bead retaining flange 180, an outboard bead seat 210, a rounded axial protuberance 220, an outboard deep well side wall 230, a deep well 240, an inboard deep well side wall 250, an inboard bead seat 260, and an inboard tire bead retaining flange 270. The length of the inner surface of the outboard bead seat 210, which is indicated by Y1, is equal in size to twice the length of the outboard face of the outboard tire bead retaining flange 180, which is indicated by X1 in FIG. 2 (i.e. Y1=2*X1). In addition, the length of the inner surface of the inboard bead seat 260, which is indicated by Y2, is equal in size to twice the length of the inboard face of the inboard tire bead retaining flange 270, which is indicated by X2 in FIG. 2 (i.e. Y2=2*X2).

FIG. 4 depicts a cross-sectional view of the disclosed wheel rim employing stick-on balancing weights in accordance with one or more embodiments of the present disclosure. This figure shows stick-on balancing weights 280 affixed to both the outboard bead seat 210 as well as the inboard bead seat 260. The stick-on balancing weight 280 that is affixed to the outboard bead seat 210 is fastened to the radial inner surface of the outboard bead seat 210 of the wheel rim 100. Similarly, the stick-on balancing weight 280 that is affixed to the inboard bead seat 260 is fastened to the radial inner surface of the inboard bead seat 260 of the wheel rim 100.

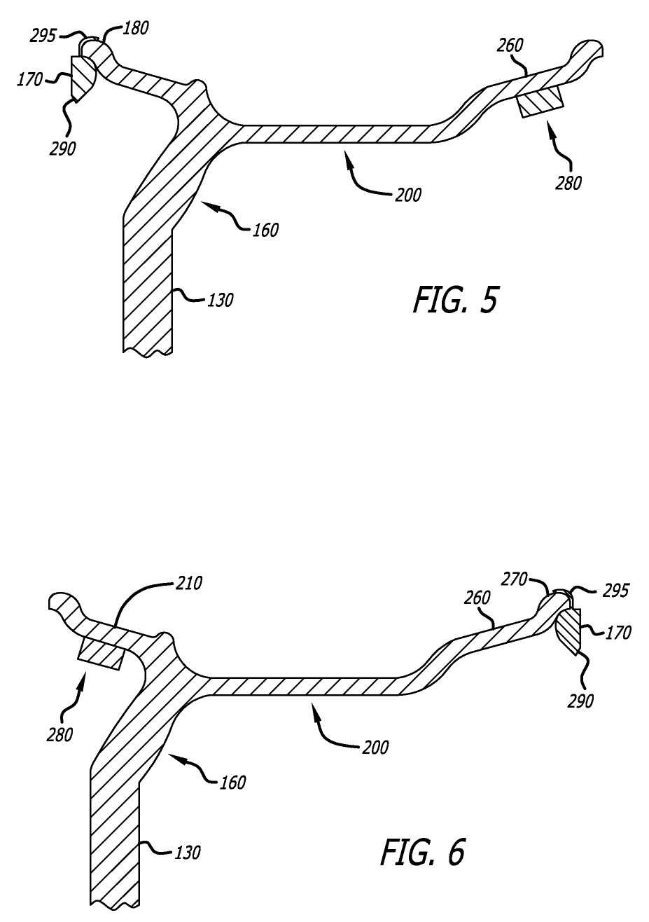

FIG. 5 shows a cross-sectional view of the disclosed wheel rim employing both clip-on balancing weights and stick-on balancing weights in accordance with one or more embodiments of the present disclosure. In this figure, a clip-on balancing weight 170 is affixed to the outboard tire bead-retaining flange 180, and a stick-on balancing weight 280 is affixed to the inboard bead seat 260. The clip-on balancing weight 170 that is affixed to the outboard tire bead retaining flange 180 has its clip 295 extending radially about the outer edge of the inboard face of the outboard tire bead retaining flange 180 and its balancing weight body 290 held against the outboard face of the outboard tire bead retaining flange 180. In addition, the stick-on balancing weight 280 that is affixed to the inboard bead seat 260 is fastened to the radial inner surface of the inboard bead seat 260 of the wheel rim 100.

FIG. 6. shows a cross-sectional view of the disclosed wheel rim employing both stick-on balancing weights and clip-on balancing weights in accordance with one or more embodiments of the present disclosure. In this figure, a clip-on balancing weight 170 is affixed to the inboard tire bead-retaining flange 270, and a stick-on balancing weight 280 is affixed to the outboard bead seat 210. The clip-on balancing weight 170 that is affixed to the inboard tire bead retaining flange 270 has its clip 295 extending radially about the outer edge of the outboard face of the inboard tire bead retaining flange 270 and its balancing weight body 290 held against the inboard face of the inboard tire bead retaining flange 270. In addition, the stick-on balancing weight 280 that is affixed to the outboard bead seat 210 is fastened to the radial inner surface of the outboard bead seat 210 of the wheel rim 100.

Alternatively, in one or more embodiments, the wheel rim 100 of the present disclosure may accommodate both clip-on balancing weights 170 and stick-on balancing weights 280 on its outboard tire bead retaining flange 180 and outboard bead seat 210, respectively. In addition, the disclosed wheel rim 100 may additionally accommodate both clip-on balancing weights 170 and stick-on balancing weights 280 on its inboard tire bead-retaining flange 270 and its inboard bead seat 260, respectively. In addition, in one or more embodiments, the wheel rim 100 of the present disclosure may accommodate other various combinations of clip-on balancing weights 170 and stick-on balancing weights.

Although certain illustrative embodiments and methods have been disclosed herein, it can be apparent from the foregoing disclosure to those skilled in the art that variations and modifications of such embodiments and methods can be made without departing from the true spirit and scope of the art disclosed. Many other examples of the art disclosed exist, each differing from others in matters of detail only. Accordingly, it is intended that the art disclosed shall be limited only to the extent required by the appended claims and the rules and principles of applicable law.

We claim:

1. A wheel rim having a rim area comprising:
an outboard tire bead-retaining flange;
an outboard bead seat;
a rounded axial protuberance;
an outboard deep well sidewall;
a deep well;
an inboard deep well sidewall;
an inboard bead seat; and
an inboard tire bead-retaining flange,
wherein the outboard tire bead-retaining flange transitions to the outboard bead seat,
wherein the outboard bead seat transitions to the rounded axial protuberance,
wherein the rounded axial protuberance transitions to an outboard deep well side wall,
wherein the outboard deep well sidewall transitions to a deep well,
wherein the deep well transitions to an inboard deep well sidewall,
wherein the inboard deep well sidewall transitions to an inboard bead seat,
wherein the inboard bead seat transitions to an inboard tire bead-retaining flange,
wherein the length of the outboard bead seat is equal to twice the length of the outboard bead-retaining flange,
wherein at least one clip-on balancing weight may be affixed to the outboard tire bead-retaining flange,
wherein the at least one clip-on balancing weight may be affixed to the inboard tire bead retaining flange,
wherein at least one stick-on balancing weight may be affixed to the radial inner surface of the outboard bead seat,
wherein the at least one stick-on balancing weight may be affixed to the radial inner surface of the inboard bead seat.

2. The wheel rim of claim 1, further comprising a wheel disk area.

3. The wheel rim of claim 2, wherein the wheel disk area includes a centrally disposed pilot opening.

4. The wheel rim of claim 2, wherein the wheel disk area includes a plurality of apertures,
wherein the plurality of apertures are to receive mounting studs.

5. The wheel rim of claim 2, wherein the wheel disk area includes a plurality of through openings.

6. The wheel rim of claim 5, wherein the plurality of through openings are circular shape.

7. The wheel rim of claim 1, wherein the at least one clip-on balancing weight comprises a balancing weight body and a clip.

8. The wheel rim of claim 7, wherein the balancing weight body of the at least one clip-on balancing weight is manufactured from lead.

9. The wheel rim of claim 1, wherein the outboard tire bead-retaining flange is formed to have a rounded, bulbous lip.

10. The wheel rim of claim 1, wherein the inboard tire bead-retaining flange is formed to have a rounded, bulbous lip.

11. A wheel rim having a rim area comprising:
an outboard tire bead-retaining flange;
an outboard bead seat;
a rounded axial protuberance;
an outboard deep well sidewall;
a deep well;
an inboard deep well sidewall;
an inboard bead seat; and
an inboard tire bead-retaining flange,
wherein the outboard tire bead-retaining flange transitions to the outboard bead seat,
wherein the outboard bead seat transitions to the rounded axial protuberance,
wherein the rounded axial protuberance transitions to an outboard deep well side wall,
wherein the outboard deep well sidewall transitions to a deep well,
wherein the deep well transitions to an inboard deep well sidewall,
wherein the inboard deep well sidewall transitions to an inboard bead seat,
wherein the inboard bead seat transitions to an inboard tire bead-retaining flange,
wherein the length of the outboard bead seat is equal to twice the length of the outboard bead-retaining flange,
wherein the length of the inboard bead seat is equal to twice the length of the inboard bead-retaining flange,
wherein at least one clip-on balancing weight may be affixed to the outboard tire bead-retaining flange,
wherein the at least one clip-on balancing weight may be affixed to the inboard tire bead retaining flange,
wherein at least one stick-on balancing weight may be affixed to the radial inner surface of the outboard bead seat,
wherein the at least one stick-on balancing weight may be affixed to the radial inner surface of the inboard bead seat.

12. The wheel rim of claim 11, further comprising a wheel disk area.

13. The wheel rim of claim 12, wherein the wheel disk area includes a centrally disposed pilot opening.

14. The wheel rim of claim 12, wherein the wheel disk area includes a plurality of apertures,
wherein the plurality of apertures are to receive mounting studs.

15. The wheel rim of claim 12, wherein the wheel disk area includes a plurality of through openings.

16. The wheel rim of claim 15, wherein the plurality of through openings are circular shape.

17. The wheel rim of claim 11, wherein the at least one clip-on balancing weight comprises a balancing weight body and a clip.

18. The wheel rim of claim 17, wherein the balancing weight body of the at least one clip-on balancing weight is manufactured from lead.
